(19) United States
(12) Patent Application Publication
(10) Pub. No.: US 2005/0253795 A1
(43) Pub. Date: Nov. 17, 2005

(54) Display device and electronic apparatus

(75) Inventors: Hidekuni Moriya, Suwa-shi (JP); Tsuyoshi Maeda, Yamanashi (JP); Keiji Takizawa, Toyoshina-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/109,651

(22) Filed: Apr. 20, 2005

(30) Foreign Application Priority Data
May 12, 2004 (JP) 2004-142342

(51) Int. Cl. G09G 3/36

(52) U.S. Cl. 345/88

(57) ABSTRACT

To provide a display device with an excellent image representation capability, which is capable of vividly reproducing colors existing in nature. A display device according to the present invention performs color reproduction by additive color mixture of four primary colored light components consisting of Red, Green, Blue, and Cyan, wherein in an xy-chromaticity diagram, the coordinate of Red is x≧0.643 (y is optional), Green is y≧0.606 (x is optional), Blue is y≦0.056 (x is optional), and Cyan is x≦0.164 (y is optional). In addition, in a u′v′-chromaticity diagram, the coordinate of Red is u′≧0.450 (v′ is optional), Green is v′≧0.569 (u′ is optional), Blue is v′≦0.149 (u′ is optional), and Cyan is u′≦0.076 (v′ is optional).

### BACKGROUND

The present invention relates to a display device and an electronic apparatus and, more particularly, to a technology for improving display color reproducibility.

In general, a color image display device, such as a liquid crystal display (LCD) or organic electroluminescent (hereinafter, referred to as EL) display, reproduces various colors by additive color mixture of three primary colors of red (R), green (G), and blue (B). In this case, the color reproduction range reproducible in image displaying is limited to an area indicated as the sum of three primary color vectors in a three-dimensional color space. In recent years, image reproducibility has been improved as an image display device is used for various purposes, for example, the image display device is required to reproduce delicate color tones. That is, the color reproduction range needs to be broadened. Increasing the saturation of a primary color is an example of broadening the color reproduction range. However, to increase the saturation of a primary color, it is necessary to reduce wavelength range of the primary color and to be close to monochromatic light. Thus, as long as a special light source such as a laser is not used, the light efficiency is inevitably decreased.

Accordingly, there has been made an attempt to broaden the color reproduction range by increasing the number of primary colors used in displaying. For example, the following Patent Document 1 discloses an image display device using four primary colors. This image display device matches R, G, and B of four primary colors with sRGB chromaticity, which is one of the standard color spaces, and broadens the color reproduction range by adding cyan (C).

[Patent Document 1] Japanese Unexamined Patent Application Publication No. 2003-228360.

However, because the image display device disclosed in patent document 1 matches the chromaticities of R, G, and B of four primary colors with sRGB chromaticity, it does not sufficiently include colors existing in nature, e.g., the color gamut which is also referred to as PointerGamut. Since a cyan is added, the color reproduction range becomes an area surrounded by a square, and thus it shows better characteristics than sRGB, but it does not include PointerGamut, for example, in Red-Yellow-Green or Red-Magenta-Blue area.

FIG. 24 is a u′v′ chromaticity diagram showing the color reproduction range of an image display device described in Patent Document 1. This drawing shows the color reproduction ranges of PointerGamut, which is a database of colors existing in nature, and sRGB, which is a standard color space, in addition to the color reproduction range of this image display device. Since the color gamut of sRGB originally does not include PointerGamut, a cyan is added. Accordingly, PointerGamut is included in the vicinity of the added cyan. Meanwhile, since R, G, and B are primary colors of sRGB, PointerGamut is not included in the Red-Yellow-Green or Red-Magenta-Blue area. Consequently, there has been a problem in that it is not possible to reproduce distinct colors in this area and to sufficiently reproduce colors defined in PointerGamut.

The present invention is intended to solve the above-mentioned problems, and it is an object of the present invention to provide a display device capable of vividly reproducing colors existing in nature, and an electronic apparatus using the same.

### SUMMARY

In order to achieve the above-mentioned objects, the present inventors have obtained through a simulation technique the range of color reproduction made by a combination of a backlight and a color filter having various spectral characteristics in an LCD having the backlight and the color filter. As a result, coordinates of each of four primary colors of Red, Green, Blue, and Cyan are defined so that the color gamut surrounded by a square made by connecting the coordinates of four primary colors can include a database of colors existing in nature which is called PointerGamut (M. R. Pointer, The Gamut of Real Surface Colours, COLOR Research and Application, Vol. 5 Num. 3, pp. 145-155, 1980). Here, the PointerGamut refers to a database in which color specimens with high saturation are collected. Since color specimens with high saturation are collected, the PointerGamut is frequently used for evaluation of color reproduction range.

In other words, the display device according to the present invention, which performs color display by emitting different colored light components and performs color reproduction by additive color mixture of four primary colored light components consisting of Red, Green, Blue, and Cyan, is characterized in that, in an xy-chromaticity diagram, the coordinate of Red is x≧0.643 (y is optional), Green is y≧0.606 (x is optional), Blue is y≦0.056 (x is optional), and Cyan is x≦0.164 (y is optional).

According to the above-mentioned configuration, because the color reproduction range in this display device includes PointerGamut, it is possible to vividly reproduce colors existing in nature, resulting in an enhanced image representation capability. A specific example thereof will be described in detail below.

In addition, the display device according to the present invention, which performs color display by emitting different colored light components and performs color reproduction by additive color mixture of four primary colored light components consisting of Red, Green, Blue, and Cyan, is characterized in that, in a u′v′-chromaticity diagram, the coordinate of Red is u′≧0.450 (v′ is optional), Green is v′≧0.569 (u′ is optional), Blue is v′≦0.149 (u′ is optional), and Cyan is u′≦0.076 (v′ is optional).

While the above-mentioned configuration is represented with the xy-chromaticity diagram, the present configuration is represented with the u′v′-chromaticity diagram. Also in this configuration, because the color reproduction range in this display device includes PointerGamut, it is possible to vividly reproduce colors existing in nature, resulting in an enhanced image representation capability. In addition, upper or lower limits of coordinates in the u′v′-chromaticity diagram of the present configuration are obtained from the following five specific examples rather than a simple conversion of upper or lower limits of the xy-chromaticity diagram into those of the u′v′-chromaticity diagram.

The display device according to the present invention, which has the above-mentioned configuration, comprises a color filter having coloring layers with different wavelength selection characteristics, a backlight for emitting illumination light having a plurality of peak wavelengths, and a liquid crystal cell for controlling the illumination light passing through the color filter.

According to this configuration, the color reproduction range in this display device includes PointerGamut, and thus it is possible to vividly reproduce colors existing in nature, resulting in an LCD with an enhanced image representation capability.

To realize the above-mentioned coordinates, in an LCD having a color filter and a backlight, the color filter may have spectral characteristics including peak wavelengths of 400 to 490 nm for Blue-colored transmission light, peak wavelengths of 490 to 520 nm for Cyan-colored transmission light, peak wavelengths of 520 to 570 nm for Green-colored transmission light, and peak wavelengths of 600 nm and more for Red-colored transmission light, and the backlight includes a three-colored light-emitting diode and has spectral characteristics including peak wavelengths of 460 nm, 540 nm, and 640 nm.

The color filter may have spectral characteristics including peak wavelengths of 400 to 490 nm for Blue-colored transmission light, peak wavelengths of 490 to 520 nm for Cyan-colored transmission light, peak wavelengths of 520 to 570 nm for Green-colored transmission light, and peak wavelengths of 600 nm and more for Red-colored transmission light, and the backlight includes a three-wavelength fluorescent tube and has spectral characteristics including peak wavelengths of 435 nm, 545 nm, and 630 nm.

The color filter may have spectral characteristics including peak wavelengths of 400 to 490 nm for Blue-colored transmission light, peak wavelengths of 490 to 520 nm for Cyan-colored transmission light, peak wavelengths of 520 to 570 nm for Green-colored transmission light, and peak wavelengths of 600 nm and more for Red-colored transmission light, and the backlight includes a three-colored light-emitting diode and has spectral characteristics including peak wavelengths of 465 nm, 520 nm, and 635 nm.

The color filter may have spectral characteristics including peak wavelengths of 400 to 490 nm for Blue-colored transmission light, peak wavelengths of 490 to 520 nm for Cyan-colored transmission light, peak wavelengths of 520 to 570 nm for Green-colored transmission light, and peak wavelengths of 600 nm and more for Red-colored transmission light, and the backlight includes a three-wavelength fluorescent tube and has spectral characteristics including peak wavelengths of 435 nm, 545 nm, and 610 nm.

An electronic apparatus according to the present invention comprises the display device or LCD according to the present invention.

According to this configuration, it is possible to realize an electronic apparatus having a display device with excellent color reproducibility by including the display device or LCD according to the present invention.

### BRIEF DESCRIPTION OF THE DRAWINGS

FIG. 1 is a schematic perspective view showing the overall configuration of an LCD according to an embodiment of the present invention;

FIG. 2 is an xy-chromaticity diagram showing the color reproduction range of the LCD;

FIG. 3 is a u′v′-chromaticity diagram showing the color reproduction range of the LCD;

FIG. 4 is a view showing a spectral characteristic of a color filter of the first embodiment;

FIG. 5 is a view showing a spectral characteristic of a backlight of the first embodiment;

FIG. 6 is an xy-chromaticity diagram of the first embodiment;

FIG. 7 is a u′v′-chromaticity diagram of the first embodiment;

FIG. 8 is a view showing a spectral characteristic of a color filter of the second embodiment;

FIG. 9 is a view showing a spectral characteristic of a backlight of the second embodiment;

FIG. 10 is an xy-chromaticity diagram of the second embodiment;

FIG. 11 is a u′v′-chromaticity diagram of the second embodiment;

FIG. 12 is a view showing a spectral characteristic of a color filter of the third embodiment;

FIG. 13 is a view showing a spectral characteristic of a backlight of the third embodiment;

FIG. 14 is an xy-chromaticity diagram of the third embodiment;

FIG. 15 is a u′v′-chromaticity diagram of the third embodiment;

FIG. 16 is a view showing a spectral characteristic of a color filter of the fourth embodiment;

FIG. 17 is a view showing a spectral characteristic of a backlight of the fourth embodiment;

FIG. 18 is an xy-chromaticity diagram of the fourth embodiment;

FIG. 19 is a u′v′-chromaticity diagram of the fourth embodiment;

FIG. 20 is a view showing a spectral characteristic of a color filter of the fifth embodiment;

FIG. 21 is a view showing a spectral characteristic of a backlight of the fifth embodiment;

FIG. 22 is an xy-chromaticity diagram of the fifth embodiment;

FIG. 23 is a u′v′-chromaticity diagram of the fifth embodiment;

FIG. 24 is a u′v′-chromaticity diagram showing the color reproduction range of an image display device of Patent Document 1; and

FIG. 25 is a perspective view showing an example of an electronic apparatus according to the present invention.

### DETAILED DESCRIPTION OF EMBODIMENTS

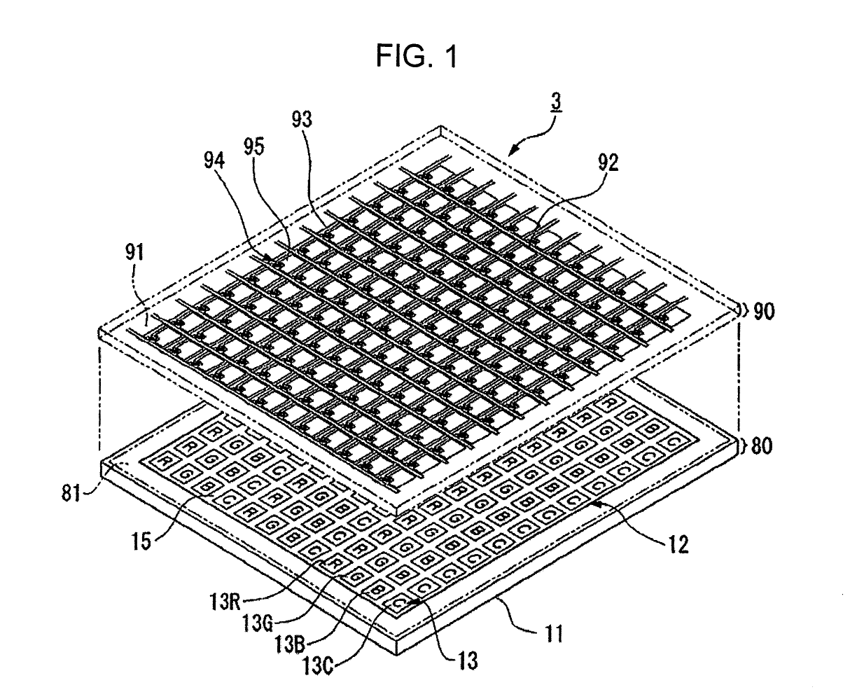

Hereinafter, an embodiment according to the present invention will be described with reference to FIGS. 1 to 3.

In the present embodiment, the present invention is applied to an active matrix type transflective LCD which uses a TFT (thin-film transistor) element as a switching element. FIG. 1 is a schematic exploded perspective view showing the overall configuration of a transflective LCD in accordance with the present embodiment.

As shown in FIG. 1, an LCD 3 according to the present embodiment comprises a liquid crystal panel comprised of a color filter substrate 80 and an element substrate (counter substrate) 90, which are faced each other and between which a liquid crystal layer (not shown) is interposed, and a backlight (not shown) disposed at a side opposite to a viewing side of the liquid crystal panel.

A TFT element 94 and a pixel electrode 95 are provided on a liquid crystal layer side surface of a substrate body 91 in the element substrate 90, and an alignment film (not shown) is provided on the liquid crystal layer side. In more detail, in the element substrate 90, a plurality of data lines 92 and a plurality of scan lines 93 are arranged to cross each other in a latticed form on a surface of the substrate body 91. The TFT element 94 is provided in the vicinity of each of intersection points between the data lines 92 and the scan lines 93, and the pixel electrode 95 is connected to the data lines 92 through the TFT element 94. A plurality of pixel electrodes 95 are arranged in a matrix form on the entire surface on the liquid crystal layer side of the element substrate 90, and each area in which each of the pixel electrodes 95 is formed corresponds to each dot in the LCD 3. Meanwhile, a transflective layer 12, a color filter 13 having coloring units 13R, 13G, 13B, and 13C, a light-shielding layer 15, an overcoat layer (not shown), a common electrode 81, and an alignment film (not shown) are provided on a liquid crystal layer side surface of a substrate body 11 provided in the color filter substrate 80.

In the present embodiment, the color filter 13 has four coloring units, i.e., a red coloring unit 13R, a green coloring unit 13G, a blue coloring unit 13B, and a cyan coloring unit 13C, and four dots of R, G, B, and C constitute a single pixel. That is, color reproduction is performed by additive color mixture of four primary colored light components consisting of Red (R), Green (G), Blue (B), and Cyan (C). As a result, the LCD according to the present embodiment has a broader color reproduction range as compared to performing color display with three colors R, G, and B.

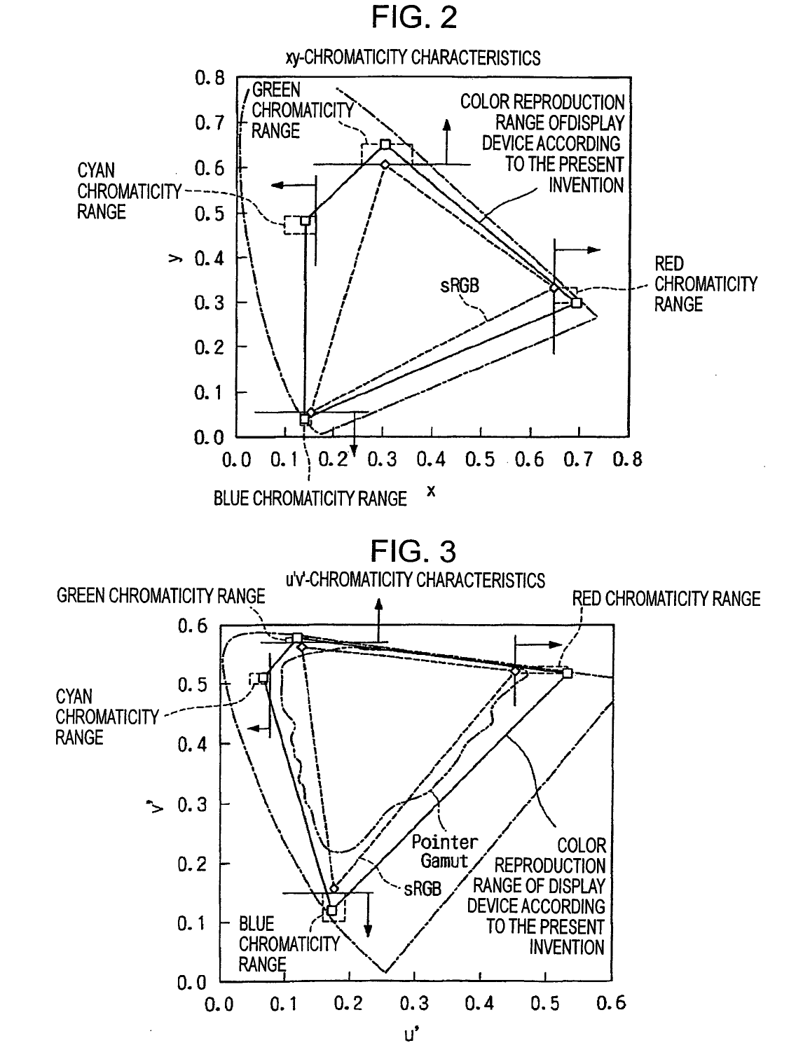

FIG. 2 is an xy-chromaticity diagram showing the color reproduction range in an LCD in accordance with the present embodiment. The xy coordinate values of each of the primary colors R, G, B, and C correspond to an area surrounded by a square shown in dotted line in FIG. 2. That is, as shown in the following [Table 1], the chromaticity ranges are as follows: the coordinate range of R is 0.643≦x≦0.690 and 0.299≦y≦0.333, the coordinate range of G is 0.257≦x≦0.357 and 0.606≦y≦0.653, the coordinate range of C is 0.098≦x≦0.164 and 0.453≦y≦0.494, and the coordinate range of B is 0.134≦x≦0.151 and 0.034≦y≦0.056.

TABLE 1

| | |
|---|---|
| x | y |

| | min | max | min | max |
|---|---|---|---|---|
| Red | 0.643 | 0.690 | 0.299 | 0.333 |
| Green | 0.257 | 0.357 | 0.606 | 0.653 |
| Cyan | 0.098 | 0.164 | 0.453 | 0.494 |
| Blue | 0.134 | 0.151 | 0.034 | 0.056 |

Similarly, FIG. 3 is a u′v′-chromaticity diagram showing the color reproduction range in an LCD in accordance with the present embodiment. The u′v′ coordinate values of each of the primary colors R, G, B, and C correspond to an area surrounded by a square shown in dotted line in FIG. 3. That is, as shown in the following [Table 2], the chromaticity ranges are as follows: the coordinate range of R is 0.450≦u′≦0.530 and 0.517≦v′≦0.525, the coordinate range of G is 0.100≦u′≦0.150 and 0.569≦v′≦0.574, the coordinate range of C is 0.046≦u′≦0.076 and 0.499≦v′≦0.517, and the coordinate range of B is 0.158≦u′≦0.194 and 0.099≦v′≦0.149.

TABLE 2

| | |
|---|---|
| u′ | v′ |

| | min | max | min | max |
|---|---|---|---|---|
| Red | 0.450 | 0.530 | 0.517 | 0.525 |
| Green | 0.100 | 0.150 | 0.569 | 0.574 |
| Cyan | 0.046 | 0.076 | 0.499 | 0.517 |
| Blue | 0.158 | 0.194 | 0.099 | 0.149 |

In FIGS. 2 and 3, the color reproduction range which can be represented by the coordinates of three primary colors of sRGB is shown with a dotted triangle. On the other hand, in the LCD according to the present embodiment, the coordinates of three primary colors RGB are located on the outer side of the coordinates of three primary colors of sRGB in the chromaticity diagram, and the color reproduction range is an area surrounded by a solid-line square by adding the color C. The square is one obtained by connecting representative primary colors, which are set in coordinate ranges of each of the primary colors. The color reproduction range surrounded by the square is nothing but an example. However, as shown in FIG. 3, while the triangle of sRGB does not include a part of PointerGamut, the square of the color reproduction range according to the present embodiment includes PointerGamut. As a result, the LCD according to the present embodiment can reproduce the overall colors defined by PointerGamut. That is, it can vividly reproduce colors existing in nature, resulting in an enhanced image representation capability.

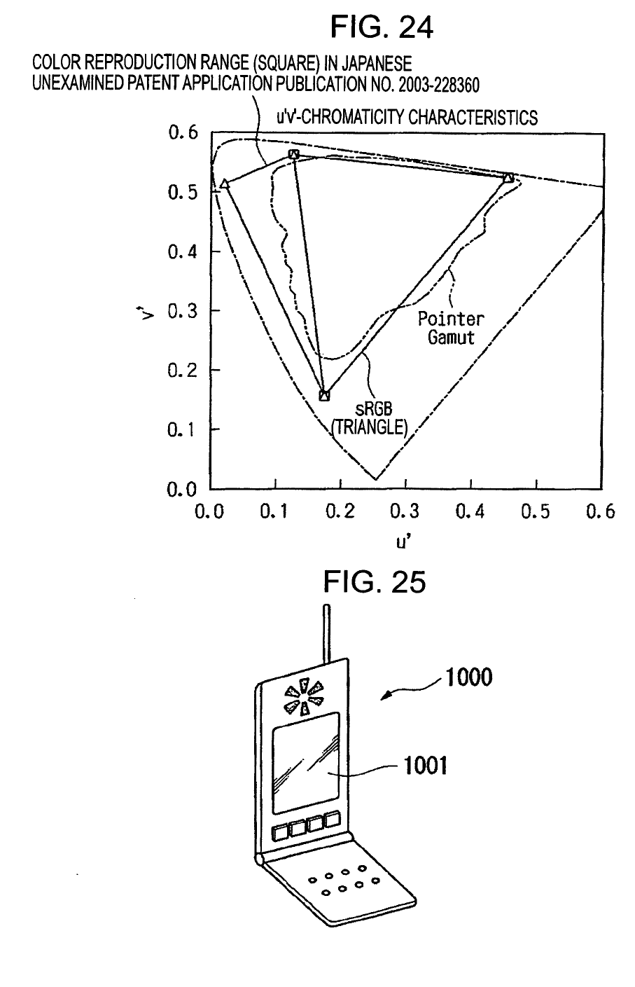

In the color reproduction range in sRGB, the area in which PointerGamut is not included is roughly divided into three sub-areas as follows: (1)Red-Yellow-Green area (the top side of an inverted triangle in the u′v′-chromaticity diagram), (2) Red-Magenta-Blue area (the right side of an inverted triangle in the u′v′-chromaticity diagram), and (3) Green-Cyan-Blue area (the left side of an inverted triangle in the u′v′-chromaticity diagram). Here, the image display device in the above-mentioned Patent Document 1, as shown in FIG. 24, includes the above (3) Green-Cyan-Blue area by adding the color Cyan. However, since the primary colors except Cyan, i.e., R, G, and B, are set in the same manner as sRGB, the above-mentioned (1) Red-Yellow-Green area and (2) Red-Magenta-Blue area are not included. On the contrary, the color reproduction range of the LCD according to the present embodiment, as described above, includes the above-mentioned (1) Red-Yellow-Green area and (2) Red-Magenta-Blue area of PointerGamut, and thus it is possible to reproduce a more distinct color as compared to the image display device in Patent Document 1.

The present embodiment defines upper and lower limits of x and y coordinates in an xy-chromaticity diagram, and upper and lower limits of u′ and v′ coordinates in a u′v′-chromaticity diagram, and defines coordinate values of each of the primary colors as areas surrounded by the dotted squares in FIGS. 2 and 3. However, although the present embodiment does not define all of those described above, in an xy-chromaticity diagram, PointerGamut is included and thus the above-mentioned effect can be achieved as long as the following condition is satisfied: i.e., the coordinate range of R is x≧0.643, G is y≧0.606, B is y≦0.056, and C is x≦0.164. Similarly, in a u′v′-chromaticity diagram, PointerGamut is included and thus the above-mentioned effect can be achieved as long as the following condition is satisfied: i.e., the coordinate range of R is u′≧0.450, G is v′≧0.569, B is v′≦0.149, and C is u′≦0.076.

In addition, PointerGamut is shown in a u′v′-chromaticity diagram of FIG. 3, but not shown in an xy-chromaticity diagram of FIG. 2. That is because it is well known that, in the xy-chromaticity diagram, distances in a drawing do not match with differences detected by human perception and thus the xy-chromaticity diagram is not suitable for evaluating the inclusion relation of color. Meanwhile, since the u′v′-chromaticity diagram is defined for the purpose of improving non-uniformity of a chromaticity diagram, it is suitable for evaluating the inclusion relation of color. That is why PointerGamut is shown only in the u′v′-chromaticity diagram. Original data in a paper which discloses PointerGamut provides saturation in relation to luminance in each hue, but FIG. 3 plots maximum saturation in each hue regardless of luminance. Also, u′ and v′ coordinates can be obtained from x and y coordinates based on the following equations (1) and (2).
u′=4x/(−2x+12y+3) (1)
v′=9y/(−2x+12y+3) (2)

In FIGS. 2 and 3, each of the primary colors, i.e., R, G, B, and C, is shown within the prescribed range using an xy- or u′v′-chromaticity diagram since the xy- or u′v′-chromaticity diagram of each of the primary colors has some degree of freedom depending on spectral characteristics of the color filter or backlight constituting an LCD. Hereinafter, exemplary embodiments are described of xy-chromaticity and u′v′-chromaticity obtained by using combinations of various color filters and backlights. The above-mentioned ranges (upper and lower limits) are based on the following 5 embodiments.

### First Embodiment

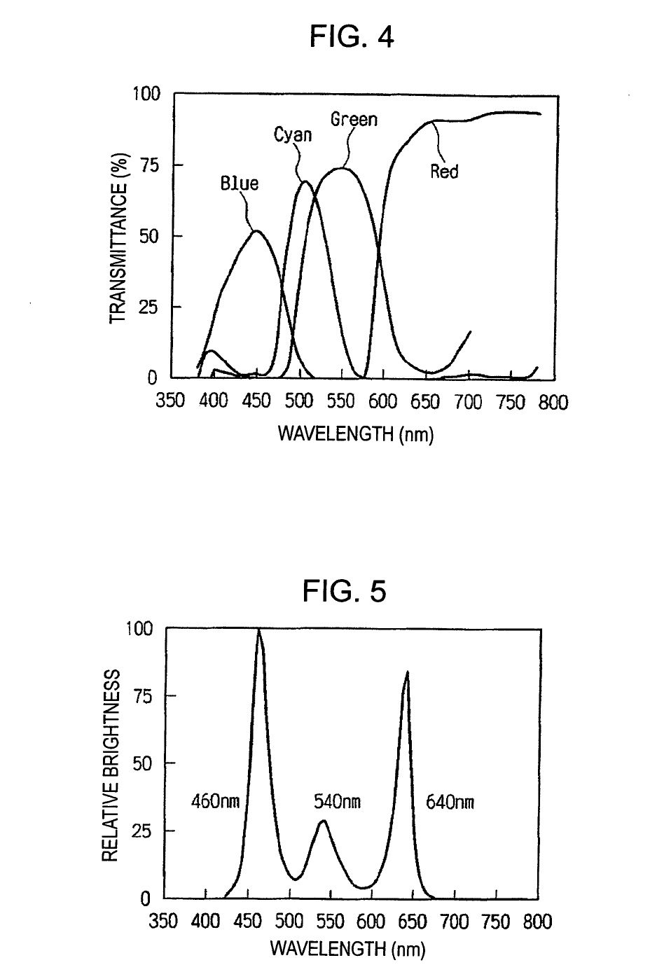

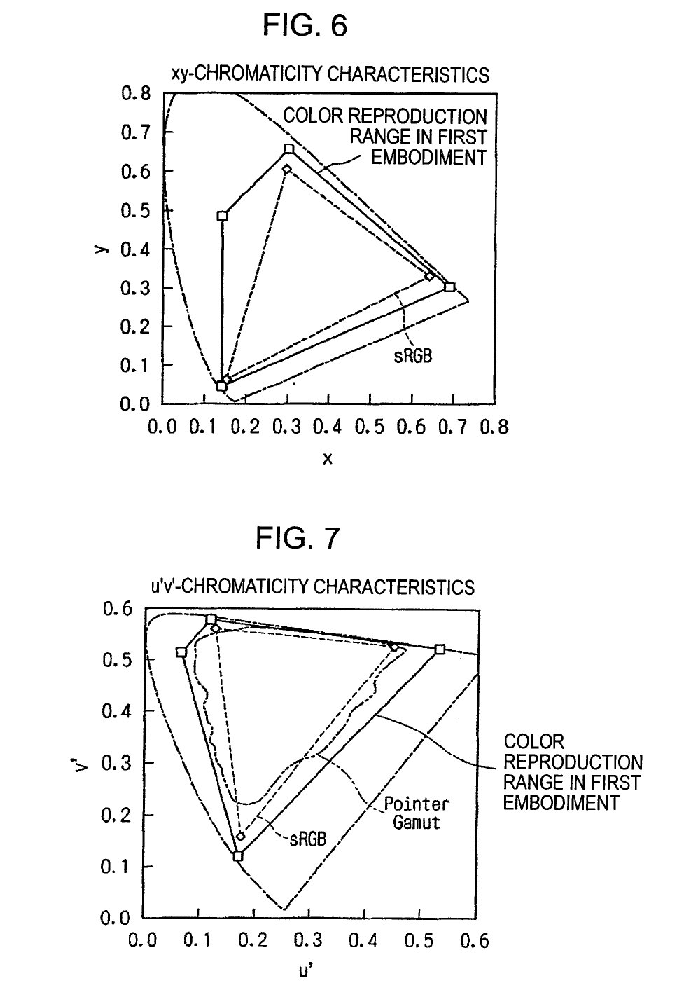

FIGS. 4 to 7 show the xy-chromaticity and u′v′-chromaticity of each of the primary colors, i.e., R, G, B, and C, which are obtained by using a color filer, a backlight, and a combination thereof according to the first embodiment. FIG. 4 shows a spectral characteristic of a color filter. FIG. 5 shows a spectral characteristic of a backlight. FIG. 6 shows an xy-chromaticity diagram. FIG. 7 shows a u′v′-chromaticity diagram. FIGS. 6 and 7 also show the color reproduction range in sRGB for comparison. In addition, FIG. 7 shows PointerGamut to check the inclusion relation of color. As well known in the art, the LCD comprises a number of components in addition to the color filter and the backlight. However, the color filter and the backlight play a major role in color reproduction and thus only the spectral characteristics of the color filter and backlight are described herein.

As shown in FIG. 4, the first embodiment uses a color filter having spectral characteristics including peak wavelengths of 400 to 490 nm for B-light, peak wavelengths of 490 to 520 nm for C-light, peak wavelengths of 520 to 570 nm for G-light, and peak wavelengths of 600 nm and more for R-light. In addition, the backlight includes a three-colored light-emitting diode (LED) having spectral characteristics including a peak wavelength of 460 nm for blue color, 540 nm for green color, and 640 nm for red color, as shown in FIG. 5.

As a result of a simulation performed using the color filter and the backlight, as shown in FIGS. 6 and 7, the xy-chromaticity and u′v′-chromaticity of each primary color are obtained (refer to Tables 3 and 4 for detailed coordinate values) and the color reproduction range shown as a square made by connecting each primary color is obtained. In particular, as shown in FIG. 7, the color reproduction range of the first embodiment includes almost entire PointerGamut, thereby reproducing a more distinct color as compared to the image display device in Patent Document 1 or sRGB.

TABLE 3

| | x | y |
|---|---|---|
| Red | 0.690 | 0.299 |
| Green | 0.302 | 0.653 |
| Cyan | 0.139 | 0.483 |
| Blue | 0.141 | 0.043 |

TABLE 4

| | u′ | v′ |
|---|---|---|
| Red | 0.530 | 0.517 |
| Green | 0.118 | 0.574 |
| Cyan | 0.065 | 0.510 |
| Blue | 0.174 | 0.120 |

### Second Embodiment

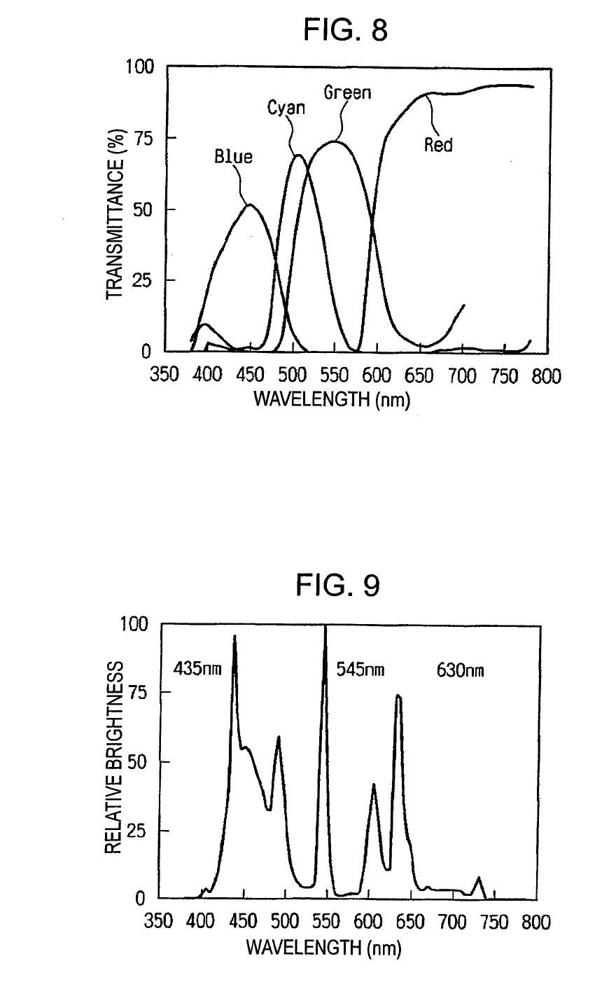

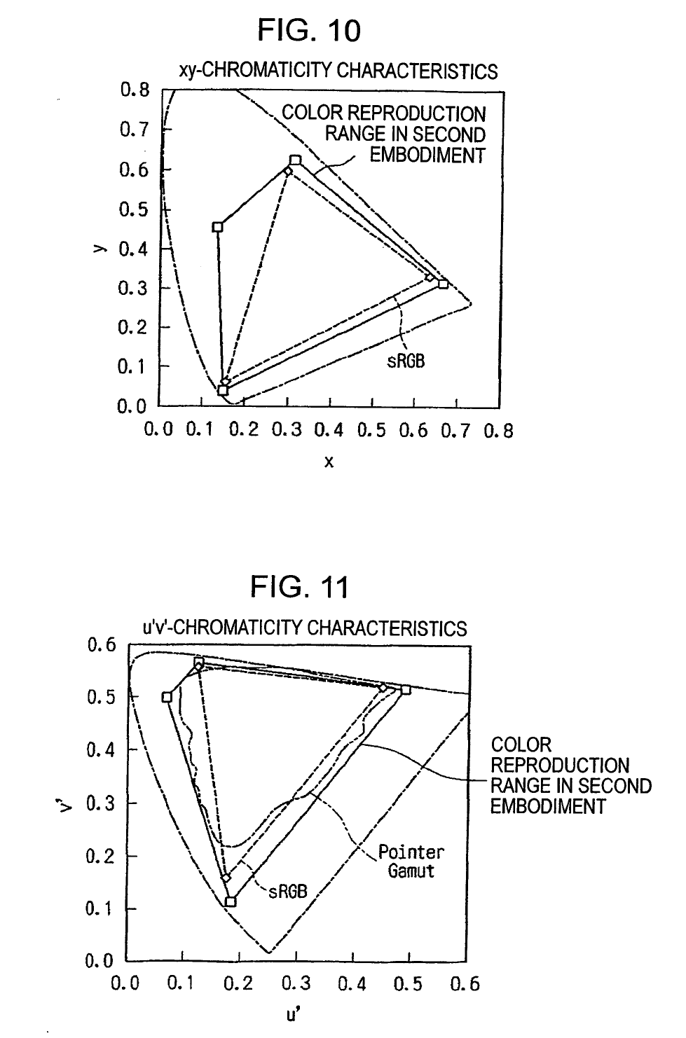

FIGS. 8 to 11 show the xy-chromaticity and u′v′-chromaticity of each of the primary colors, i.e., R, G, B, and C, which are obtained by using a color filer, a backlight, and a combination thereof according to the second embodiment. FIG. 8 shows a spectral characteristic of a color filter. FIG. 9 shows a spectral characteristic of a backlight. FIG. 10 shows an xy-chromaticity diagram. FIG. 11 shows a u′v′-chromaticity diagram. FIGS. 10 and 11 show the color reproduction range in sRGB for comparison. In addition, FIG. 11 shows PointerGamut to check the inclusion relation of color.

As shown in FIG. 8, the second embodiment uses the same color filter as in the first embodiment. Meanwhile, differently from the first embodiment, the backlight includes a fluorescent tube having three-colored peak wavelengths, i.e., a peak wavelength of 435 nm for blue color, 545 nm for green color, and 630 nm for red color, as shown in FIG. 9.

As a result of a simulation performed using the color filter and the backlight, as shown in FIGS. 10 and 11, the xy-chromaticity and u′v′-chromaticity of each primary color are obtained (refer to Tables 5 and 6 for detailed coordinate values) and the color reproduction range shown as a square made by connecting each primary color is obtained. In particular, as shown in FIG. 11, the color reproduction range of the second embodiment includes almost entire PointerGamut. As a result, also in case of employing the backlight which uses the three-wavelength fluorescent tube, it is possible to reproduce a more distinct color as compared to the image display device in Patent Document 1 or sRGB.

TABLE 5

| | x | y |
|---|---|---|
| Red | 0.665 | 0.314 |
| Green | 0.314 | 0.626 |
| Cyan | 0.135 | 0.453 |
| Blue | 0.148 | 0.040 |

TABLE 6

| | u′ | v′ |
|---|---|---|
| Red | 0.489 | 0.520 |
| Green | 0.127 | 0.570 |
| Cyan | 0.066 | 0.499 |
| Blue | 0.186 | 0.113 |

### Third Embodiment

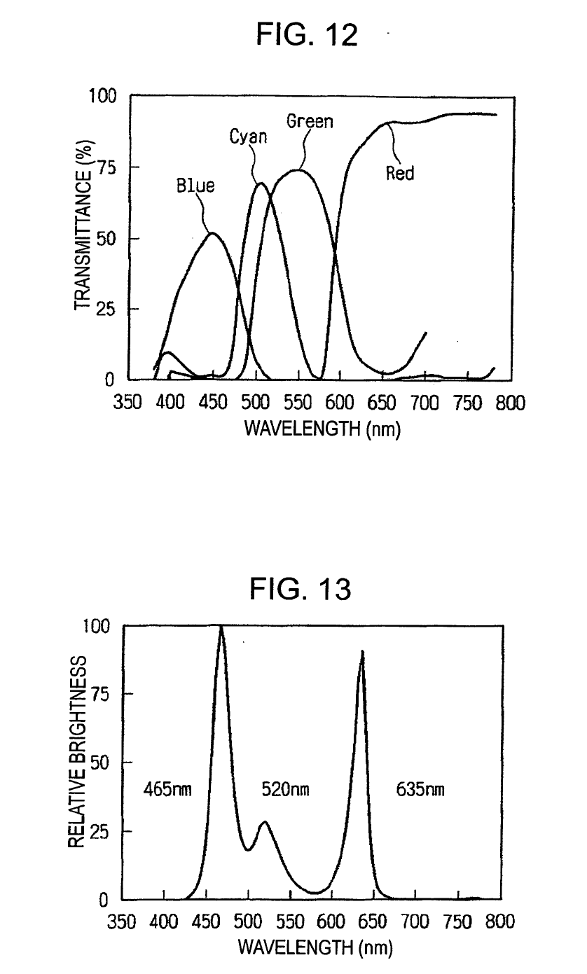

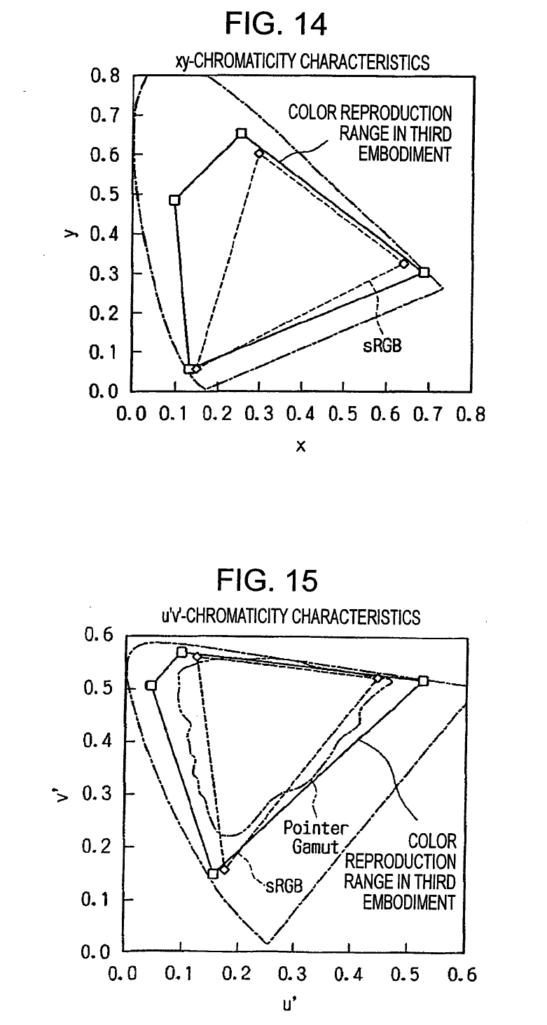

FIGS. 12 to 15 show the xy-chromaticity and u′v′-chromaticity of each of the primary colors, i.e., R, G, B, and C, which are obtained by using a color filer, a backlight, and a combination thereof according to the third embodiment. FIG. 12 shows a spectral characteristic of a color filter. FIG. 13 shows a spectral characteristic of a backlight. FIG. 14 shows an xy-chromaticity diagram. FIG. 15 shows a u′v′-chromaticity diagram. FIGS. 14 and 15 show the color reproduction range in sRGB for comparison. In addition, FIG. 15 shows PointerGamut to check the inclusion relation of color.

As shown in FIG. 12, the third embodiment uses the same color filter as in the first embodiment. Meanwhile, the backlight includes a three-colored LED having peak wavelengths different from the first embodiment. That is, as shown in FIG. 13, the LED has a peak wavelength of 465 nm for blue color, 520 nm for green color, and 635 nm for red color (460 nm, 540 nm, and 640 nm, respectively, in the first embodiment).

As a result of a simulation performed using the color filter and the backlight, as shown in FIGS. 14 and 15, the xy-chromaticity and u′v′-chromaticity of each primary color are obtained (refer to Tables 7 and 8 for detailed coordinate values) and the color reproduction range shown as a square made by connecting each primary color is obtained. In particular, as shown in FIG. 15, the color reproduction range of the third embodiment has (1) Red-Yellow-Green area (the upper side of an inverted triangle in the u′v′-chromaticity diagram) a little narrower compared to that in the first and second embodiments. However, when compared to the color reproduction range in sRGB, (2) Red-Magenta-Blue area (the right side of an inverted triangle in the u′v′-chromaticity diagram) and (3) Green-Cyan-Blue area (the left side of an inverted triangle in the u′v′-chromaticity diagram) more include PointerGamut. As a result, also in a case of employing the backlight which uses the three-colored LED having different peak wavelengths (in a case of changing a single-element LED), it is possible to reproduce a more distinct color as compared to the image display device in Patent Document 1 or sRGB.

TABLE 7

| | x | y |
|---|---|---|
| Red | 0.690 | 0.303 |
| Green | 0.257 | 0.652 |
| Cyan | 0.098 | 0.482 |
| Blue | 0.134 | 0.055 |

TABLE 8

| | u′ | v′ |
|---|---|---|
| Red | 0.524 | 0.519 |
| Green | 0.100 | 0.569 |
| Cyan | 0.046 | 0.505 |
| Blue | 0.158 | 0.147 |

### Fourth Embodiment

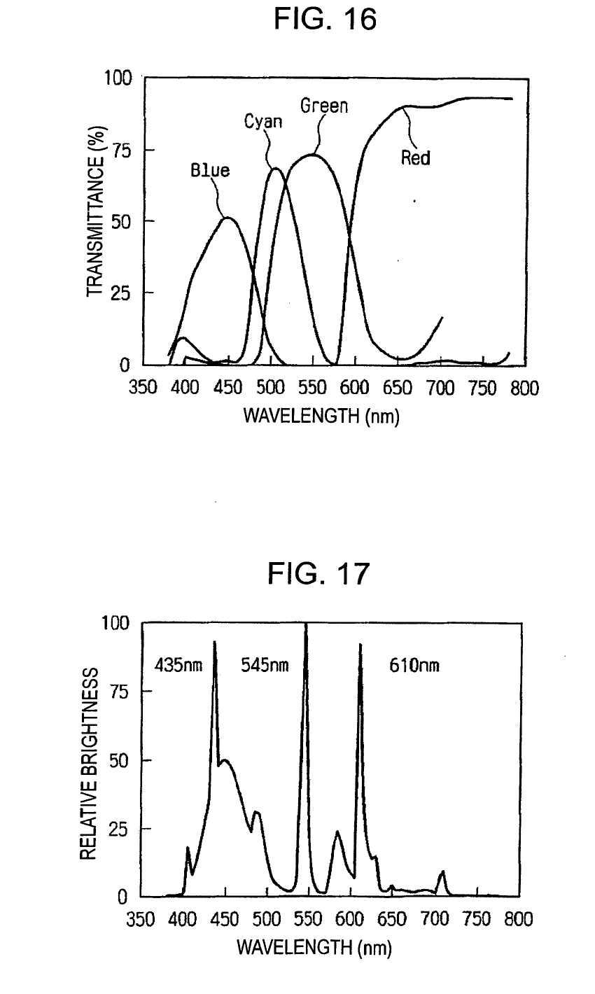

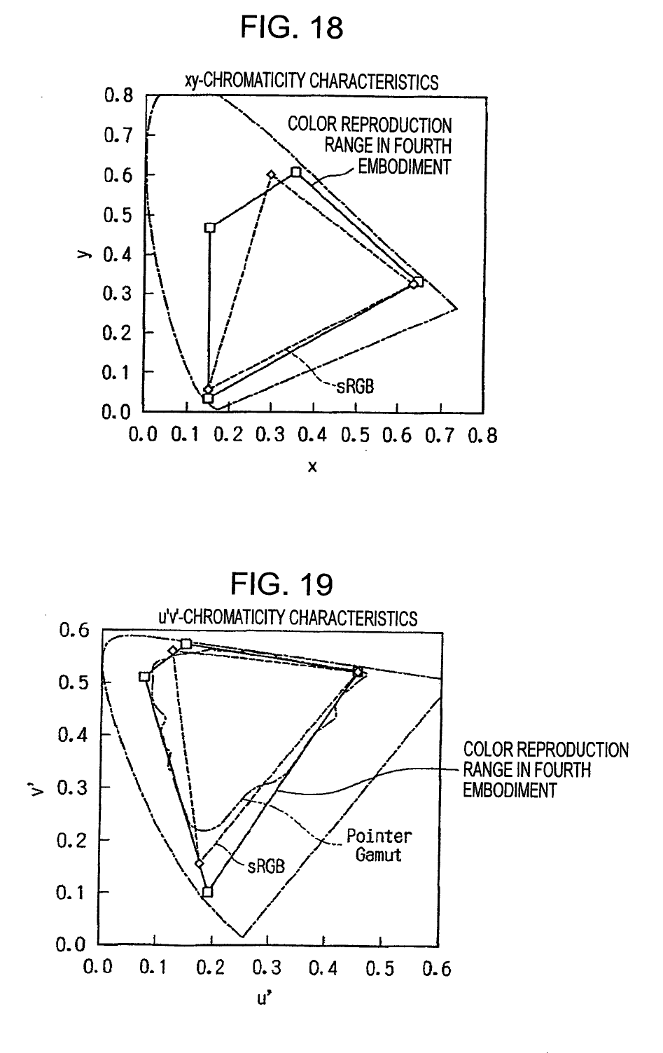

FIGS. 16 to 19 show the xy-chromaticity and u′v′-chromaticity of each of the primary colors, i.e., R, G, B, and C, which are obtained by using a color filer, a backlight, and a combination thereof according to the fourth embodiment. FIG. 16 shows a spectral characteristic of a color filter. FIG. 17 shows a spectral characteristic of a backlight. FIG. 18 shows an xy-chromaticity diagram. FIG. 19 shows a u′v′-chromaticity diagram. FIGS. 18 and 19 show the color reproduction range in sRGB for comparison. In addition, FIG. 19 shows PointerGamut to check the inclusion relation of color.

As shown in FIG. 16, the fourth embodiment uses the same color filter as in the first embodiment. Meanwhile, the backlight includes a three-colored fluorescent tube having peak wavelengths different from the second embodiment. That is, as shown in FIG. 17, the fluorescent tube has a peak wavelength of 435 nm for blue color, 545 nm for green color, and 610 nm for red color (630 nm for red color in the second embodiment).

As a result of a simulation performed using the color filter and the backlight, as shown in FIGS. 18 and 19, the xy-chromaticity and u′v′-chromaticity of each primary color are obtained (refer to Tables 9 and 10 for detailed coordinate values) and the color reproduction range shown as a square made by connecting each primary color is obtained. In particular, as shown in FIG. 19, the color reproduction range of the fourth embodiment has (2) Red-Magenta-Blue area (the right side of an inverted triangle in the u′v′-chromaticity diagram) a little narrower compared to that in the first and second embodiments. Also, the primary color of Green does not include Green in sRGB. These are caused by the spectral characteristics of the color filter and the backlight set in the fourth embodiment. However, from a point of view of whether PointerGamut is included or not, (1) Red-Yellow-Green area (the upper side of an inverted triangle in the u′v′-chromaticity diagram) and (3) Green-Cyan-Blue area (the left side of an inverted triangle in the u′v′-chromaticity diagram) more include PointerGamut, compared to the color reproduction range in sRGB. As a result, also in a case of employing the backlight which uses the three-wavelength fluorescent tube having different peak wavelengths (in a case of changing fluorescent material), it is possible to vividly reproduce colors defined in PointerGamut as compared to the image display device in Patent Document 1 or sRGB.

TABLE 9

| | x | y |
|---|---|---|
| Red | 0.644 | 0.332 |
| Green | 0.357 | 0.606 |
| Cyan | 0.157 | 0.470 |
| Blue | 0.151 | 0.034 |

TABLE 10

| | u′ | v′ |
|---|---|---|
| Red | 0.452 | 0.524 |
| Green | 0.150 | 0.571 |
| Cyan | 0.075 | 0.508 |
| Blue | 0.194 | 0.099 |

### Fifth Embodiment

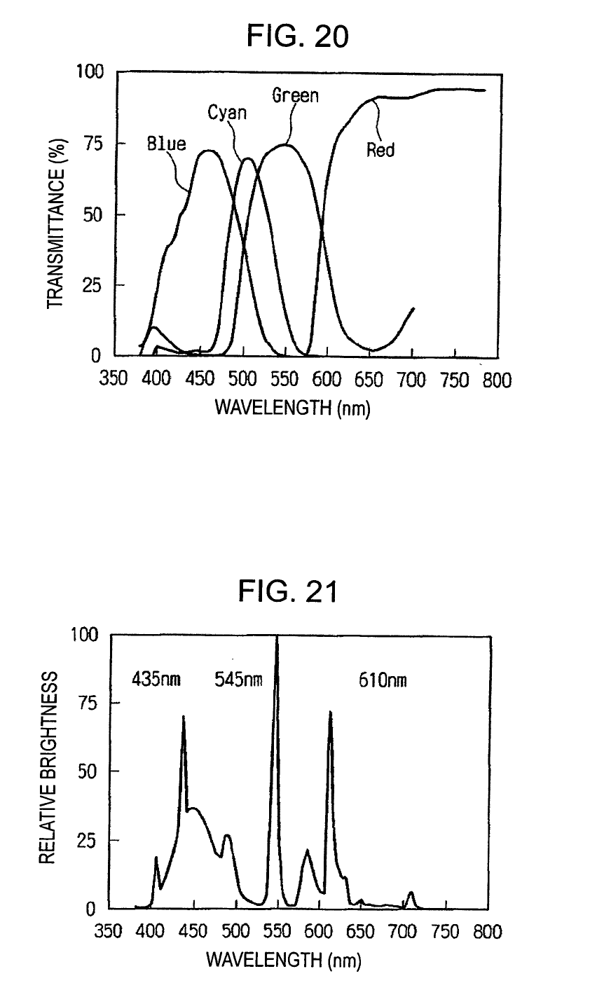

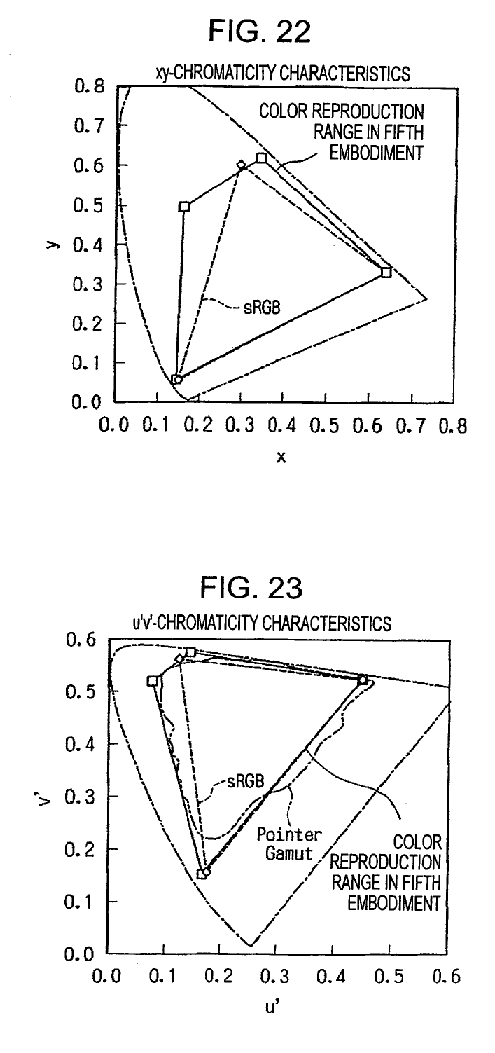

FIGS. 20 to 23 show the xy-chromaticity and u′v′-chromaticity of each of the primary colors, i.e., R, G, B, and C, which are obtained by using a color filer, a backlight, and a combination thereof according to the fifth embodiment. FIG. 20 shows a spectral characteristic of a color filter. FIG. 21 shows a spectral characteristic of a backlight. FIG. 22 shows an xy-chromaticity diagram. FIG. 23 shows a u′v′-chromaticity diagram. FIGS. 22 and 23 show the color reproduction range in sRGB for comparison. In addition, FIG. 23 also shows PointerGamut to check the inclusion relation of color.

As shown in FIG. 21, the fifth embodiment uses the same backlight as the fourth embodiment, but uses a color filter different from the first through fourth embodiments. That is, as shown in FIG. 20, the fifth embodiment is different from the first to fourth embodiments in terms of a characteristic of a blue color filter. That is, as the peak wavelength of the blue color is shifted toward longer wavelengths (approximately 460 nm), its transmittance increases. The characteristic of color filter differs due to a different color additive.

As a result of a simulation performed using the color filter and the backlight, as shown in FIGS. 22 and 23, the xy-chromaticity and u′v′-chromaticity of each primary color are obtained (refer to Tables 11 and 12 for detailed coordinate values) and the color reproduction range shown as a square made by connecting each primary color is obtained. In particular, as shown in FIG. 23, the color reproduction range of the fifth embodiment has (2) Red-Magenta-Blue area (the right side of an inverted triangle in the u′v′-chromaticity diagram) equal to sRGB, as compared to that in the first and second embodiments. Also, the primary color of Green does not include Green in sRGB. These are caused by the spectral characteristics of the color filter and the backlight set in the fifth embodiment. However, from a point of view of whether PointerGamut is included or not, (2) Red-Magenta-Blue area is equal to sRGB, but (1) Red-Yellow-Green area (the upper side of an inverted triangle in the u′v′-chromaticity diagram) and (3) Green-Cyan-Blue area (the left side of an inverted triangle in the u′v′-chromaticity diagram) more include PointerGamut, compared to the color reproduction range in sRGB. As a result, also in a case of changing the color filter, it is possible to vividly reproduce colors defined in PointerGamut as compared to the image display device in Patent Document 1 or sRGB.

TABLE 11

| | x | y |
|---|---|---|
| Red | 0.643 | 0.333 |
| Green | 0.350 | 0.616 |
| Cyan | 0.164 | 0.494 |
| Blue | 0.143 | 0.056 |

TABLE 12

| | u′ | v′ |
|---|---|---|
| Red | 0.450 | 0.525 |
| Green | 0.144 | 0.572 |
| Cyan | 0.076 | 0.517 |
| Blue | 0.169 | 0.149 |

### Electronic Apparatus

A description will be given of an electronic apparatus equipped with the LCD according to the above-mentioned embodiments.

FIG. 25 is a perspective view showing an example of a mobile phone. In FIG. 25, a main body of the mobile phone is denoted by reference numeral 1000, and a display unit using the above-mentioned LCD is denoted by 1001.

Since the electronic apparatus shown in FIG. 25 comprises the LCD according to the above-mentioned embodiments, it is possible to realize a mobile electronic apparatus having a liquid crystal display unit with excellent color reproducibility.

In addition, while the present invention has been described with reference to exemplary embodiments thereof, it will be understood by those skilled in the art that various changes in form and details may be made therein without departing from the scope of the present invention as defined by the following claims. For instance, the present invention is applied to an active matrix type transflective LCD which uses a TFT element in the above-mentioned embodiments, but not limited thereto. That is, the present invention can be also applied to an active matrix type, passive matrix type, transmissive, or reflective LCD which uses a TFT element. In addition, the present invention can be applied to a variety of display devices such as an organic EL display or a plasma display as well as a LCD. Further, examples of the electronic apparatus according to the present invention include a personal digital assistant (PDA), a photoviewer, etc., in addition to a mobile phone.

1. A display device for performing color display by emitting different colored light components and performing color reproduction by additive color mixture of four primary colored light components consisting of Red, Green, Blue, and Cyan,
wherein, in an xy-chromaticity diagram, the coordinate of Red is x≧0.643 (y is optional), Green is y≧0.606 (x is optional), Blue is y≦0.056 (x is optional), and Cyan is x≦0.164 (y is optional).

2. A display device for performing color display by emitting different colored light components and performing color reproduction by additive color mixture of four primary colored light components consisting of Red, Green, Blue, and Cyan,
wherein, in a u′v′-chromaticity diagram, the coordinate of Red is u′≧0.450 (v′ is optional), Green is v′≧0.569 (u′ is optional), Blue is v′≦0.149 (u′ is optional), and Cyan is u′≦0.076 (v′ is optional).

3. The display device according to claim 1, comprising:
a color filter having coloring layers with different wavelength selection characteristics;
a backlight for emitting illumination light having a plurality of peak wavelengths; and
a liquid crystal cell for controlling the illumination light passing through the color filter.

4. The display device according to claim 3, comprising the color filter and the backlight,
wherein the color filter has spectral characteristics including peak wavelengths of 400 to 490 nm for Blue-colored transmission light, peak wavelengths of 490 to 520 nm for Cyan-colored transmission light, peak wavelengths of 520 to 570 nm for Green-colored transmission light, and peak wavelengths of 600 nm and more for Red-colored transmission light; and
the backlight includes a three-colored light-emitting diode and has spectral characteristics including peak wavelengths of 460 nm, 540 nm, and 640 nm.

5. The display device according to claim 3, comprising the color filter and the backlight,
wherein the color filter has spectral characteristics including peak wavelengths of 400 to 490 nm for Blue-colored transmission light, peak wavelengths of 490 to 520 nm for Cyan-colored transmission light, peak wavelengths of 520 to 570 nm for Green-colored transmission light, and peak wavelengths of 600 nm and more for Red-colored transmission light, and
the backlight includes a three-wavelength fluorescent tube and has spectral characteristics including peak wavelengths of 435 nm, 545 nm, and 630 nm.

6. The display device according to claim 3, comprising the color filter and the backlight,
wherein the color filter has spectral characteristics including peak wavelengths of 400 to 490 nm for Blue-colored transmission light, peak wavelengths of 490 to 520 nm for Cyan-colored transmission light, peak wavelengths of 520 to 570 nm for Green-colored transmission light, and peak wavelengths of 600 nm and more for Red-colored transmission light, and
the backlight includes a three-colored light-emitting diode and has spectral characteristics including peak wavelengths of 465 nm, 520 nm, and 635 nm.

7. The display device according to claim 3, comprising the color filter and the backlight,
wherein the color filter has spectral characteristics including peak wavelengths of 400 to 490 nm for Blue-colored transmission light, peak wavelengths of 490 to 520 nm for Cyan-colored transmission light, peak wavelengths of 520 to 570 nm for Green-colored transmission light, and peak wavelengths of 600 nm and more for Red-colored transmission light, and
the backlight includes a three-wavelength fluorescent tube and has spectral characteristics including peak wavelengths of 435 nm, 545 nm, and 610 nm.

8. An electronic apparatus comprising the display device according to claim 1.
